(19) United States
(12) Patent Application Publication
(10) Pub. No.: US 2023/0339351 A1
(43) Pub. Date: Oct. 26, 2023

(54) CHARGING STATION, MORE PARTICULARLY MOBILE CHARGING STATION

(71) Applicant: Argo GmbH, Gräfelfing (DE)

(72) Inventor: Jan ANDREAS, Wesel (DE)

(21) Appl. No.: 18/246,491

(22) PCT Filed: Sep. 23, 2021
(86) PCT No.: PCT/EP2021/076191

§ 371 Date: Mar. 23, 2023

(30) Foreign Application Priority Data
Sep. 24, 2020 (DE) 10 2020 212 018.8

(51) Int. Cl. B60L 53/57; B60L 53/66; B60L 53/14; B60S 5/02; B60L 53/51; B60L 53/54; B60L 53/302; B60L 53/80

(52) U.S. Cl. CPC B60L 53/57; B60L 53/66; B60L 53/14; B60S 5/02; B60L 53/51; B60L 53/54; B60L 53/302; B60L 53/80

(57) ABSTRACT

The present invention relates to a charging station (100), more particularly a mobile charging station, for supplying or charging preferably electrical loads (200), in particular vehicles with electric drives, with electrical energy, in particular electric current, and/or fuel, in particular hydrogen or ethanol, comprising: at least one fuel storage (110), in particular a high-pressure storage for storing compressed hydrogen, and at least one connection (120, 130) for the discharge of: electrical energy, in particular electric current, or fuel, in particular hydrogen or ethanol, to an electrical load (200), in particular a vehicle with an electric drive, wherein the at least one fuel storage (110) is configured to be replaceably or exchangeably connected, in particular connected in a fluid-conducting manner, to the charging station (100) or to be accommodated therein.

### TECHNICAL FIELD

The present invention relates to a charging station, more particularly a mobile charging station, for suppling or charging preferably electrical loads, in particular vehicles with electric drives, with electrical energy, in particular electric current and/or fuel, in particular hydrogen or ethanol.

### PRIOR ART

In road traffic, vehicles with electric drives or auxiliary drives are also increasingly being used in addition to conventional vehicles driven by internal combustion engines, in particular motor vehicles. For example, high-performance accumulators or fuel cells are used to supply the drive with electrical energy. Additionally, there are also vehicles driven by hydrogen engines or natural gas combustion engines. An appropriate infrastructure must be provided for the charging of the accumulators or the filling of the fuel tanks and storage vessels of the vehicles.

To that end, for example, DE 10 2007 040 923 A1 describes a method for refueling electric drive vehicles, in which electrical energy is generated by a stationary fuel cell in an electric pillar, which is powered by natural gas.

Moreover, known from DE 10 2008 050 389 A1 is a method for the energy storage in large-scale power networks and energy storages suitable for this purpose. It is suggested to equip a plurality of current collectors connected to the power network with individual energy storages that can be used to buffer consumption peaks. The individual energy storages can be equipped with a connection for charging car batteries. Alternatively, the individual energy storages can be configured as electrolyzers for hydrogen generation using electrical energy from the power network. The hydrogen thus generated can then be used for further energy conversion.

Furthermore, many municipalities and commercial providers recently turned to individual means of transport such as e-bikes, e-rollers, e-scooters and the like to relieve in particular the local transport in inner cities and to make it more environmentally friendly, in particular to shift the generation of harmful exhaust gases to outside the cities or preferably to become completely CO2 neutral. However, the successful implementation of these plans imperatively requires a functioning and dense infrastructure of charging stations or filling facilities. There is therefore a great need for cost-effective charging stations which, on the one hand, can be installed without much effort and, on the other hand, preferably offer the possibility to place the charging stations in line with demand.

### DESCRIPTION OF THE INVENTION

Against the background of the need described above, it is one object of the present invention to provide a charging station, more particularly a mobile charging station, for supplying preferably electrical loads with electrical energy and/or fuel, the charging station being capable of being installed or set up easily and in restricted spaces, for example in parking lots, pedestrian zones, concert grounds, exhibition centers and the like, in a quick and cost-effective manner, preferably also for only a short time. Furthermore, the proposed charging station should be quickly refillable with fuel, in particular hydrogen or ethanol, wherein a time-consuming and inefficient refueling process should preferably be avoided.

The aforementioned object is solved by a charging station according to claim 1. Preferred further developments of the invention are given in the dependent claims.

One of the basic ideas of the present invention is to provide a charging station having a fuel storage, in particular a high-pressure storage for storing compressed hydrogen, which is configured to be replaceably or exchangeably connected, in particular connected in a fluid-conducting manner, to the charging station or to be accommodated therein in a replaceable or an exchangeable manner.

In this way, a charging station can be provided which, on the one hand, is independent of location since the required fuel, in particular hydrogen, for providing fuel or electrical energy that is generated by converting the fuel, is stored or temporarily stored directly in the charging station and, on the other hand, allows the charging station to be quickly filled with new fuel since a usually lengthy and elaborate filling process of the fuel storage can be avoided. Instead, the empty fuel storage is simply replaced with a full fuel storage.

According to one aspect of the present invention, a charging station, more particularly a mobile charging station, for supplying or charging preferably electrical loads, in particular electrical drive vehicles, with electrical energy, in particular electric current, and/or fuel, in particular hydrogen or ethanol, comprises: at least one fuel storage, in particular a high-pressure storage for storing compressed hydrogen, and at least one connection for the discharge of: electrical energy, in particular electric current, or fuel, in particular hydrogen or ethanol, to a preferably electric load, in particular an electric drive vehicle, wherein the at least one fuel storage is configured to be replaceably or exchangeably connected, in particular connected in a fluid-conducting manner, to the charging station or to be accommodated therein in a replaceable or an exchangeable manner.

In the context of the present invention, the term “vehicle” or “means of transport” or other similar terms include motor vehicles in general, such as passenger automobiles comprising sports utility vehicles (SUVs), buses, trucks, various commercial vehicles, water vehicles comprising various boats and ships, aircraft, aerial drones and the like, hybrid vehicles, electric vehicles, plug-in hybrid electric vehicles, hydrogen vehicles, and other alternative vehicles. As stated herein, hybrid vehicles are vehicles having two or more energy carriers, e.g. gasoline-powered and simultaneously electrically powered vehicles. Hydrogen vehicles can be vehicles powered with drive current by fuel cells or vehicles with fuel engines that are configured for the combustion of hydrogen.

Furthermore, in the context of the present invention, the term “load”, in particular “electrical load”, includes all devices which use electrical energy, in particular electric current, to be supplied with or driven by energy. On the one hand, these can be devices having an accumulator in which the electrical energy is temporarily stored until it is used, or devices which generate the electric current “on demand”, preferably by using a hydrogen fuel cell which is itself supplied with energy by hydrogen or, for example, ethanol and converts it into electrical energy, in particular electric current.

Moreover, in the context of the present invention, “supplying or charging” is understood to mean that, on the one hand, an accumulator installed in the load or device is supplied with electrical energy, thus charging the accumulator or, on the other hand, a fuel storage, in particular a high-pressure storage, installed in the load or device, in particular a vehicle, is supplied with fuel, in particular compressed hydrogen or ethanol, and is thus filled again.

In the context of the present invention, the terms “replaceable” or “exchangeable” define that a particular device, in particular the at least one fuel storage of the charging station, is configured to be easily and quickly separated from the charging station, in particular a supply system or hydrogen supply system of the charging station, in order to replace, for example, the empty fuel storage with a full fuel storage, and thus the charging station can be supplied with fuel, in particular compressed hydrogen, without a great deal of effort, in particular without the need to laboriously fill a fuel storage that is permanently installed in the charging station. Thus, recharging the charging station with required or new hydrogen is possible in just a few minutes. This also means that the specific device is configured to be disconnected from and reconnected to the charging station in a non-destructive manner.

According to one embodiment of the present invention, the at least one fuel storage is replaceably connected or connectable in a fluid-conducting manner to the charging station, in particular a hydrogen supply system, by means of a quick coupling. The quick coupling is preferably configured such that the fuel storage can be disconnected from the charging station without having to reduce the pressure in the charging station, in particular in the hydrogen supply system of the charging station.

In this regard, the quick coupling is preferably configured as shown in the application entitled “SYSTEM FOR CONNECTING AN ELEMENT TO A COUNTERPART IN A FLUID-CONDUCTING MANNER, ADAPTER MEMBER AND ADAPTER HOUSING FOR CONNECTION IN A FLUID-CONDUCTING MANNER AS WELL AS ADAPTER SYSTEM COMPRISING THE ADAPTER MEMBER AND THE ADAPTER HOUSING” filed on 3 Aug. 2020 with application number: DE 10 2020 209 735.6. Accordingly, all of the essential features of this application, such as the claims thereof, and/or the features described therein and corresponding to and/or relating to the present application, are incorporated herein by this reference and can be combined with the feature combinations disclosed herein to provide an improved quick coupling, and protection can be sought for the resulting feature combinations.

A basic idea of the system (quick coupling) described in DE 10 2020 209 735.6 is to provide a system for connecting/joining an element to a counterpart in a flow-conducting or fluid-conducting manner, which system comprises two seals disposed in a fluid channel one behind the other in an outflow direction of a fluid, in particular a gas, out of the counterpart (in the present invention out of the hydrogen supply system of the charging station), which fluid channel connects the element to the counterpart in a flow-conducting or fluid-conducting, in particular a gas-conducting manner, the first seal being formed from a valve body and a first sealing member, the valve body being configured to be shifted or movable between an open position, in which a fluid, in particular gas, can flow through the fluid channel, and a closed position, in which no fluid can flow through the channel. The second seal, which is disposed in the fluid channel downstream of the first seal in the outflow direction of the fluid flowing through/flowing out through the fluid channel is configured to seal, in particular in a gas-tight manner, a connecting region between the fluid channel and the element, the second seal being configured such that when connecting/joining the element to the counterpart, it seals the connecting region before the first seal can be/is mechanically shifted or moved into the open position.

According to a further embodiment of the present invention, it can be advantageous if the at least one connection is an electrical connection for discharging electrical energy, in particular electric current, which is preferably used for electrically charging an accumulator of the electrical load.

Moreover, the electrical loads can be selected from the group of: Vehicles, in particular motor vehicles, with electric drive or auxiliary drive, e-bikes (201), e-scooters, e-rollers, laptops, mobile phones and the like.

According to a further embodiment of the present invention, the at least one connection can be a fluid-conducting connection, in particular a hydrogen connection, which is preferably used for filling at least one storage vessel of a vehicle with fuel, in particular compressed hydrogen. It is particularly preferred in this regard that the fluid-conducting connection is a filling connection according to SAE J 2601.

It is also conceivable here that the at least one connection is configured to transmit both electrical energy and fuel, in particular hydrogen, to a load. Thus, both charging processes can be carried out at one connection, in particular one charging point.

It is furthermore advantageous if the charging station has at least one electrical connection and one fluid-conducting connection, preferably at least two fluid-conducting connections and a plurality of electrical connections. The respective connections can hereby be provided at respectively different positions in or at the charging station, thus allowing to supply several loads with electrical energy and/or fuel, in particular hydrogen, at the same time.

According to a further embodiment, the at least one connection is configured as a fast-charging station, in particular a fast-charging pillar, for electric vehicles.

It is further preferred that the at least one connection, which is configured as an electrical connection, in particular an electric charging pillar, is adapted to be arranged or set up at a predetermined distance, in particular at least 5 meters, from the charging station. This has the advantage that especially in the case of several electrical connections or electric charging pillars, these can be set up at a distance from each other, thus creating sufficient space for several vehicles that can be supplied or charged with electric current at the same time. Furthermore, specific safety regulations with regard to explosion protection and the like can thus be complied with.

Moreover, it is advantageous if the charging station has at least one hydrogen fuel cell configured to generate electrical energy, in particular electric current, by extracting fuel stored in the fuel storage, in particular hydrogen, further preferably compressed hydrogen, or ethanol, and to make the electric current thus obtained or generated available to at least one electrical connection, preferably several electrical connections.

It is further preferred that the hydrogen fuel cell is configured as a reversible hydrogen fuel cell which comprises a subunit for the production of hydrogen by electrolysis and a subunit for the production of electrical energy by oxidation of hydrogen. In this way, at times when there are no loads, in other words no loads to be charged, the charging station can use electrical energy from the network, for example when there is an oversupply of electricity in the network (times when a lot of energy is fed into the network due to photovoltaic systems or wind turbines), or electricity generated by means of the photovoltaic system of the charging station, to produce hydrogen and thereby fill the fuel storage, in particular a high-pressure vessel for hydrogen, with hydrogen.

According to a further embodiment of the present invention, the at least one fuel storage is configured as an exchangeable vessel or the at least one fuel storage is integrated into an exchangeable device such as an exchangeable container or an exchangeable pallet, which is preferably configured as a mobile exchangeable device.

It is advantageous here if a plurality of fuel storages is integrated into the exchangeable device, and the exchangeable device is configured as a mobile means of transport, in particular a vehicle or truck trailer or a self-propelled vehicle such as a drone.

If the exchangeable device is configured as an autonomous or self-propelled vehicle, a changeover operation of the exchangeable device, in particular of the fuel vessel, can be carried out completely without human intervention, which can further reduce the costs for the provision of hydrogen. In this regard, it is advantageous if the connection of the fuel vessel to the supply system, in particular the hydrogen supply system, of the charging station is made by means of a quick coupling, in particular an automatic quick coupling, which also does not require human intervention.

For example, the autonomous or self-propelled vehicle can be configured to autonomously drive with a filled fuel tank from a hydrogen production plant, such as a wind power plant or a photovoltaic system, to the charging station and to replace an emptied fuel tank there.

Furthermore, the charging station can have a housing structure, in particular a mobile housing structure, which is preferably formed from a lightweight frame structure, such as aluminum profiles, and is preferably configured to accommodate, in particular in a storage space within the housing structure, the at least one fuel storage and/or the exchangeable device.

The housing structure can advantageously be provided with solar cells, in particular with a photovoltaic system, which is preferably installed on a roof of the housing structure.

As already indicated, the charging station can thus generate electrical energy by itself, in particular electric current, which on the one hand can be used to supply the loads with electrical energy, and on the other hand can be used to produce hydrogen by means of the reversible hydrogen fuel cell or a separate electrolyzer.

It may be advantageous here to provide the charging station with a compressor, in particular a hydrogen compressor, by means of which the generated hydrogen can be compressed or condensed to a desired pressure of approximately 300 bar to 1200 bar and can then be temporarily stored or buffered in the at least one fuel storage, in particular high-pressure storage or high-pressure hydrogen storage.

In this regard, a hydrogen compressor is understood to be a device which, using a liquid, in particular water, that is introduced or pumped into a space, compresses a volume of hydrogen confined in this space, in particular hydrogen gas, to a desired pressure. A device of this type, in particular a filling device for filling at least one storage vessel with compressed hydrogen, comprises a compression device which, for compression of the hydrogen, has a pressure vessel into which the hydrogen to be compressed can be introduced, wherein the hydrogen in this pressure vessel can preferably be enclosed by valves, and the hydrogen can be compressed by increasing the liquid volume of a compression liquid, in particular water, which can be introduced into the pressure vessel.

As regards further details of the so-called hydrogen compressor, reference is made to the application DE 10 2020 207 827.0 entitled “Filling device for filling storage tanks with compressed hydrogen, refueling station having the same, and method of filling a storage tank” filed on 24 Jun. 2020, and it is announced that all of the features that are essential for the application DE 10 2020 207 827.0 such as, for example, the claims thereof and/or claims included therein, and which correspond and/or refer to the features of the present application, are incorporated by reference herein and can be combined with feature combinations disclosed herein to provide an improved charging station, and protection can be sought for the resulting feature combinations.

A basic idea of the device described in DE 10 2020 207 827.0 (water compressor) is that a filling device for filling at least one storage vessel (in the present invention the at least one fuel storage or exchangeable device of the charging station) with compressed hydrogen is equipped with a compression device which, for compression of the hydrogen, has a pressure vessel into which the hydrogen to be compressed can be introduced, wherein the hydrogen in this pressure vessel can preferably be enclosed by valves, and the hydrogen can be compressed by increasing a liquid volume of a compression liquid, in particular of water, which can be introduced into the pressure vessel.

According to a further embodiment of the present invention, the charging station can also be provided with a storage space for pressure storages, in particular high-pressure hydrogen storages such as exchangeable vessels for home refueling stations or other home appliances. The storage space can be provided with an automatic door or an output tray, by means of which the pressure storage can be handed over to potential customers after payment.

Moreover, it is advantageous if the charging station is provided with at least one beverage vending machine for hot and/or cold beverages and/or one fresh produce vending machine for, for example, snacks, dairy products, sandwiches, baguettes and the like.

Furthermore, it is preferred that the housing structure has a lateral access, in particular an up-and-over door, a wing door, a sectional door or a rolling door, which is preferably electrically operable or can be electrically opened and closed.

According to a further embodiment, the charging station is configured as a mobile charging station, in particular as a mobile setup such as a truck trailer or in the form of a modular system that is configured to be assembled and disassembled from individual modules in just a few assembly steps.

Moreover, the charging station can comprise a temporary storage, in particular an accumulator, which is configured for the temporary storage of the electrical energy, in particular electric current, generated by the hydrogen fuel cell, and/or the electrical energy generated by a/the photovoltaic system.

It is furthermore preferred that the charging station is provided with a control device configured to control and/or regulate the supply of the at least one connection with electrical energy or fuel, in particular hydrogen.

Here, it is further preferred that the charging station comprises a communication device, in particular a wireless communication device using infrared, radio, Bluetooth, or WLAN (wireless local area network), which is configured to communicate with the electrical loads, in particular control units of the electrical loads, or users of the charging station, in particular in order to start and/or control and/or regulate a refueling or charging process. The communication device and/or control device can thereby be configured such that, by means thereof, user identification or payment is performed before the refueling or charging process takes place.

Furthermore, it can be advantageous here that the communication device is configured to communicate with the control device, in particular to communicate with it in order to start and/or control and/or regulate a refueling or charging process of the electrical loads.

According to a further embodiment, the charging station can be equipped with a defibrillator that is preferably provided in an easily accessible manner.

It is furthermore preferred that the charging station is provided with a cooling chamber which is preferably provided within a housing of the charging station, and which is configured to accommodate and cool the at least one exchangeable or replaceable fuel storage.

### BRIEF DESCRIPTION OF THE FIGURES

Further features and advantages of a device, a use and/or a method are apparent from the following description of embodiments with reference to the accompanying figures. In these figures,

FIG. 1 schematically shows a known electric charging pillar with a stationary fuel cell,

FIG. 2 schematically shows one embodiment of the charging station according to the invention from the front,

FIG. 3 schematically shows the charging station according to the invention of FIG. 2 from the rear and the top, and

FIG. 4 schematically shows the charging station according to the invention of FIG. 2 from the side, the side wall having been removed for the sake of better illustration.

### DESCRIPTION OF EMBODIMENTS

Identical reference numbers used in different figures designate identical, corresponding or functionally similar elements.

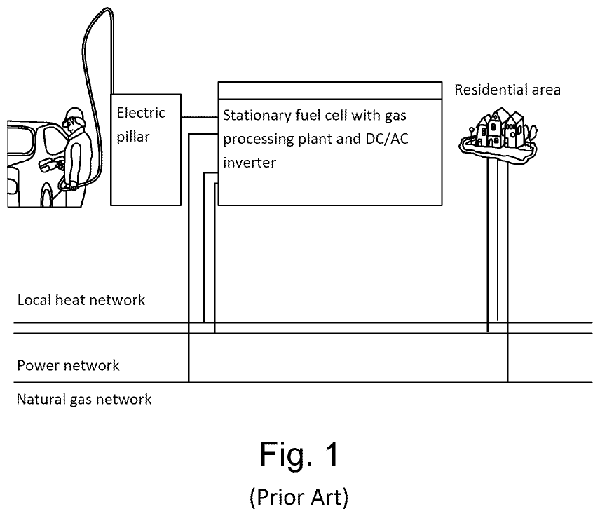

FIG. 1 schematically shows a known electric charging pillar with a stationary fuel cell. It is illustrated how a stationarily installed fuel cell can be operated to generate the energy required for hydrogen production as efficiently and decentrally as possible. In this regard, combined heat and power plants are used to generate the electrical energy; district heating or electricity from the power network can also be used here. The fuel cell can also be supplied with primary energy through connection to the natural gas network. It is important here that the electric filling station is in a place that allows the use of waste heat from an industrial or commercial or residential area.

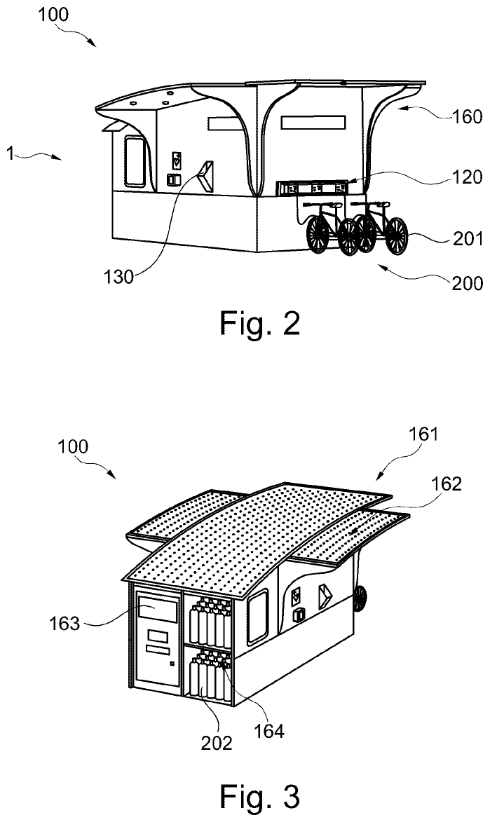

FIG. 2 schematically shows an embodiment of a charging station 100 according to the invention from the front. As can be seen from FIG. 2, the illustrated charging station 100 has an elongated housing structure 160 in the form of a kiosk. In other words, this is a small building with projecting roofings on three sides that serve as rain protection for users of the charging station. Furthermore, FIG. 2 shows that the illustrated charging station is provided with three electrical connections 120 or connection panels at the front which, for example, can be used for charging e-bikes 201 (loads 200). For this purpose, the electrical connections 120 or connection panels can be provided with ordinary socket connections, USB connections or other common electrical connections.

On the left side in FIG. 2, the charging station is provided with a fluid-conducting connection 130 which, for example, can be used for filling a vehicle with hydrogen. However, the connection 130 shown here also has an electrical connection which can be used, for example, to charge an accumulator of an electric vehicle. Furthermore, a defibrillator 195 is provided on the left side of the housing structure 160.

As can be seen from FIG. 3, the illustrated charging station 100 is equipped with a photovoltaic system 162 that is provided on a roof 161 of the housing structure 160. In this manner, the charging station can gain additional electrical energy that can be supplied to the loads 200 or an electrolyzer for hydrogen production. Moreover, the electrical energy thus obtained can be temporarily stored in an accumulator. A fresh food vending machine 163 is provided at the rear of the illustrated charging station 100, which, using the electrical energy generated in the charging station, can provide, for example, hot baked goods such as baguettes. In addition, the rear of the charging station 100 is provided with a storage space 164 in which a plurality of (full or empty) pressure storages can be provided for sale or replacement.

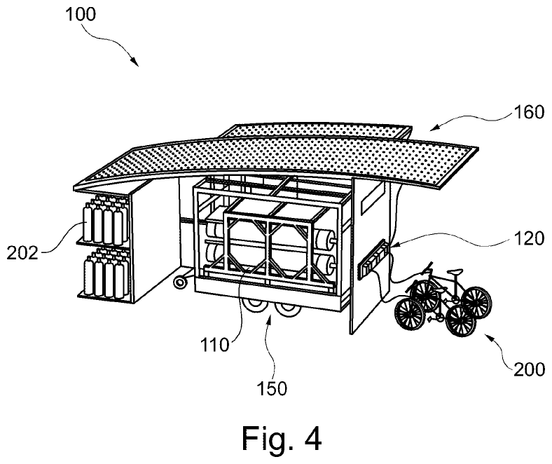

FIG. 4 schematically shows the charging station 100 according to the invention of FIG. 2 from the side, the side wall not being shown for better illustration. As is apparent from FIG. 4, an exchangeable device 150 is provided or parked inside the charging station 100, in particular inside the housing structure 160, which in the embodiment shown is configured in the form of a vehicle trailer. This is a vehicle trailer with a known drawbar for attachment to a vehicle as well as a chassis with a twin axle. Provided on the vehicle trailer is a lightweight structure in which a plurality of fuel storages 110, preferably four or six fuel storages, are accommodated, which are combined to form a high-pressure storage system and can be connected via a quick coupling to a supply system, in particular a hydrogen supply system, of the charging station 100. The vehicle trailer is further provided with known safety technology such as thermal pressure relief valves (TPRDs) and the like. The individual fuel storages, in particular high-pressure hydrogen storages, are configured to receive compressed fuel at pressures of up to 1200 bar.

In order to be able to accommodate the vehicle trailer 150 within the housing structure 160, the housing structure 160 is provided with a roll-up door (not shown) on the left side which allows access to the interior of the housing structure 160. As is further apparent from FIG. 4, the housing structure 160 in this embodiment is built as a modular system of individual modules which can thus be quickly assembled and disassembled, with which the charging station 100 is configured as a so-called mobile charging station that can be set up according to the requirements at different locations such as pedestrian zones, exhibition centers, fairs and the like.

Further provided within the charging station 100, in particular the housing structure 160, are a hydrogen fuel cell 140 (not shown) as well as an accumulator (not shown) which constitute parts of the supply system or hydrogen supply system of the charging station 100. In this manner, the hydrogen stored in the fuel storages 110 can be used to generate electrical energy, in particular electric current, which can be provided to the loads 200 via the electrical connections 120.

### LIST OF REFERENCE NUMBERS

100 charging station
110 fuel storage
120 electrical connection
130 fluid-conducting connection
140 hydrogen fuel cell
150 exchangeable device
160 housing structure
161 roof
162 photovoltaic system
163 fresh produce vending machines
164 storage space
170 temporary storage (accumulator)
180 control device
200 electrical load
201 e-bike
202 pressure storage (exchangeable vessel)

1. Charging station (100), more particularly mobile charging station, for supplying preferably electrical loads (200), in particular vehicles with electric drives, with electrical energy, in particular electric current, and/or fuel, in particular hydrogen or ethanol, comprising:
at least one fuel storage (110), in particular a high-pressure storage for storing compressed hydrogen, and
at least one connection (120, 130) for the discharge of:
electrical energy, in particular electric current, or
fuel, in particular hydrogen or ethanol,
to a preferably electrical load (200), in particular a vehicle with an electric drive,
wherein the at least one fuel storage (110) is configured to be replaceably connected, in particular connected in a fluid-conducting manner, to the charging station (100), or to be accommodated in the charging station.

2. Charging station (100) according to claim 1, in which the at least one connection (120, 130) is an electrical connection (120) for the discharge of electrical energy, in particular electric current, which is preferably used for electrically charging an accumulator (210) of the electrical load (200).

3. Charging station (100) according to claim 1 or 2, in which the electrical loads are selected from the group of: vehicles, in particular motor vehicles, with electric drive or auxiliary drive, e-bikes (201), e-scooters, e-rollers, laptops, mobile phones, etc.

4. Charging station (100) according to one of the preceding claims, in which the at least one connection (120, 130) is a fluid-conducting connection (130), in particular a hydrogen connection, which is preferably used for filling at least one storage vessel of a vehicle with fuel, in particular compressed hydrogen, wherein the fluid-conducting connection (130) preferably is a filling connection according to SAE J 2601.

5. Charging station (100) according to one of the preceding claims, further comprising at least one electrical connection (120) and one fluid-conducting connection (130), preferably at least two fluid-conducting connections (130) and a plurality of electrical connections (120).

6. Charging station (100) according to one of the preceding claims, wherein the at least one connection (120) is configured as a fast-charging station, in particular a fast-charging pillar, for electric vehicles.

7. Charging station (100) according to one of the preceding claims, wherein the at least one connection (120) is an electrical connection, in particular an electric charging pillar, configured to be arranged at a distance or set up at a predetermined distance, in particular at least 5 meters, from the charging station (100).

8. Charging station (100) according to one of the preceding claims, further comprising at least one hydrogen fuel cell (140) configured to generate electrical energy, in particular electric current, by removing fuel, in particular hydrogen or ethanol, stored in the fuel storage and to make it available to at least one electrical connection (120).

9. Charging station (100) according to claim 8, in which the hydrogen fuel cell (140) is configured as a reversible hydrogen fuel cell including a subunit for producing hydrogen by electrolysis and a subunit for producing configured to generate electrical energy by oxidation of hydrogen.

10. Charging station (100) according to one of the preceding claims, wherein the at least one fuel storage (110) is configured as an exchangeable vessel, or the at least one fuel storage (110) is integrated into an exchangeable device (150) which preferably is a mobile exchangeable device.

11. Charging station (100) according to one of the preceding claims, further comprising an exchangeable device (150) into which a plurality of fuel storages (110) is integrated, and which is configured as a mobile means of transport, in particular a vehicle trailer or a self-propelled vehicle.

12. Charging station (100) according to one of the preceding claims, further comprising a housing structure (160), in particular a mobile housing structure, which is preferably formed from a lightweight frame structure, and is preferably configured to accommodate the at least one fuel storage (110) and/or the exchangeable device (150), in particular in a storage space within the housing structure (160).

13. Charging station (100) according to claim 12, in which the housing structure (160) is provided with solar cells, in particular a photovoltaic system (162), which are preferably installed on a roof (161) of the housing structure (160).

14. Charging station (100) according to claim 12 or 13, in which the housing structure (160) is further provided with a storage space for pressure storages, in particular high-pressure hydrogen storages.

15. Charging station (100) according to one of the preceding claims, further comprising at least one beverage vending machine for hot and/or cold drinks and/or one fresh produce vending machines (163) for, for example, snacks, dairy products, sandwiches, baguettes and the like.

16. Charging station (100) according to one of the preceding claims and claim 12, wherein the housing structure (160) further comprises a lateral access, in particular an up-and-over door, a barn door, a sectional door or a roll-up door, which is preferably electrically operable, further preferably can be electrically opened and closed.

17. Charging station (100) according to one of the preceding claims, wherein the charging station (100) is configured as a mobile charging station, in particular as a mobile setup such as, for example, a truck trailer, or in the form of a modular system configured to be assembled and disassembled from individual modules with a few assembly steps.

18. Charging station (100) according to one of the preceding claims and claim 8, further comprising a temporary storage (170), in particular an accumulator, configured for the temporary storage of the electrical energy, in particular electric current, generated by the hydrogen fuel cell (140) and/or the electrical energy generated by a photovoltaic system (162).

19. Charging station (100) according to one of the preceding claims, further comprising a control device (180) configured to control and/or regulate the supply of the at least one connection (120, 130) with electrical energy or fuel, in particular hydrogen.

20. Charging station (100) according to one of the preceding claims, further comprising a communication device (190), in particular a wireless communication device, using infrared, radio, Bluetooth, or WLAN (wireless local area network), configured to communicate with electrical loads (200), in particular control units of the electrical loads, or users of the charging station (100), in particular to start and/or control and/or regulate a refueling or charging process.

21. Charging station (100) according to claims 19 and 20, wherein the communication device (190) is further configured to communicate with the control device (180), in particular to communicate with it in order to start and/or control and/or regulate a refueling or charging process of the electrical loads.

22. Charging station (100) according to one of the preceding claims, further comprising a defibrillator (195).

23. Charging station (100) according to one of the preceding claims, further comprising a cooling chamber configured to receive and cool the at least one fuel storage (110).

24. Charging station (100) according to one of the preceding claims, wherein the at least one fuel storage (110) is replaceably connected to the charging station (100) in a fluid-conducting manner by means of a quick coupling.
